(19) United States
(12) Patent Application Publication
(10) Pub. No.: US 2016/0201893 A1
(43) Pub. Date: Jul. 14, 2016

(54) ILLUMINATED SEAL BASE FOR MOBILE LIVING QUARTERS

(71) Applicant: LTI FLEXIBLE PRODUCTS, INC., Modesto, CA (US)

(72) Inventor: Edwin E Ksiezopolski, Granger, IN (US)

(73) Assignee: LTI FLEXIBLE PRODUCTS, INC., Modesto, CA (US)

(21) Appl. No.: 14/594,223

(22) Filed: Jan. 12, 2015

(51) Int. Cl. F21V 33/00; E04B 1/68

(52) U.S. Cl. CPC F21V 33/006; E04B 1/6815; E04B 1/681; E04B 1/6803; F21Y 2103/003

(57) ABSTRACT

An illuminated slide-out seal assembly is provided where the seal base is attached to an existing aperture. The seal base has an illuminating portion located between two rails and resides under a removable translucent bulb seal. The bulb seal has a first diffusing section and a second diffusing section. The first diffusing section is stiffer and resists movement. The second diffusing section is more flexible and can compress when outside force is applied.

### BACKGROUND OF THE INVENTION

This present disclosure relates to a seal for sealing a slide-out room and main living quarters and having illumination. Slide out rooms are commonplace in the RV industry and illumination is a commonly desired feature. The illumination could be for accent lighting, decoration, background lighting, or for safety. Currently if lighting is needed in the seal area, a separate illuminating piece is required, allowing the possibility of exposed wiring, electrical shorts, and complex installation. An integrated lighting and sealing solution is needed.

### SUMMARY OF THE INVENTION

The present disclosure describes using a translucent bulb seal in conjunction with the seal base incorporating a LED strip that illuminates through the bulb seal and provides a diffused illumination projecting outward. Compression of the seal does not result in damage to the seal or LED strip. The LED strip can be illuminated while compressed or in the resting position.

### BRIEF DESCRIPTION OF THE DRAWINGS

A preferred embodiment of this invention has been chosen wherein:

FIG. 1 is a side view of the device as installed on a trailer;

FIG. 2 is top view of section 2-2 of the trailer in FIG. 1;

FIG. 3 is partial section 3 of the section 2-2 in FIG. 2;

FIG. 4 is an isometric view of the seal assembly;

FIG. 5 is an isometric view of the seal base as installed on a sidewall;

FIG. 6 is a top view of the seal base;

FIG. 7 is a top view of the seal assembly as installed; and

FIG. 8 is a top view of the seal assembly as installed with a bulb seal compressed.

### DESCRIPTION OF THE PREFERRED EMBODIMENT

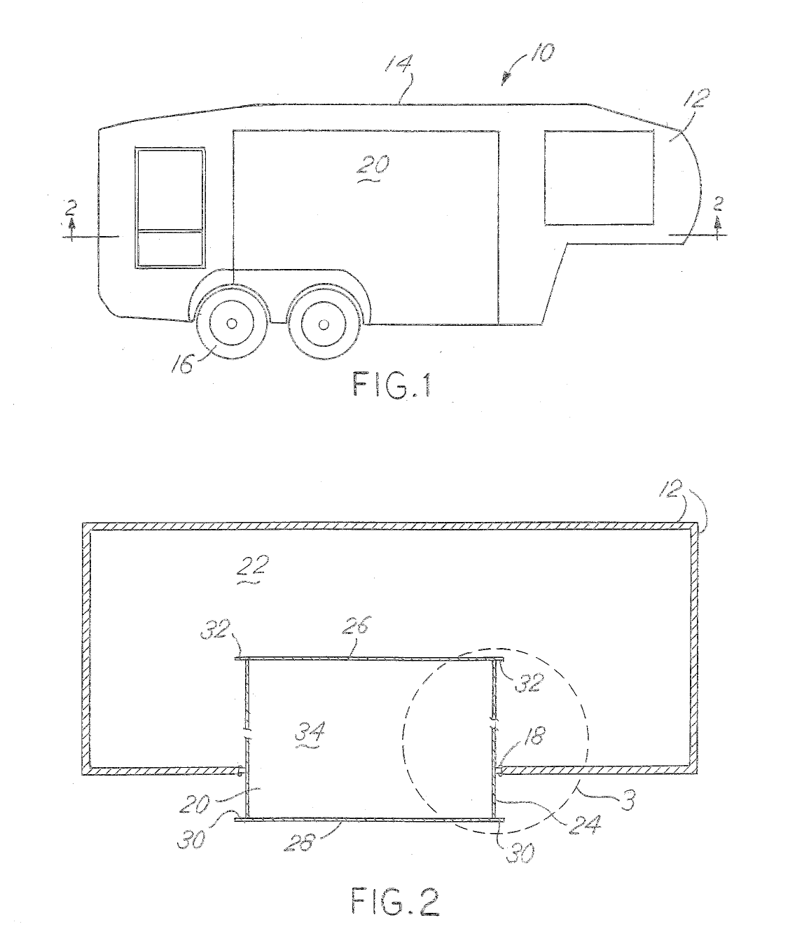

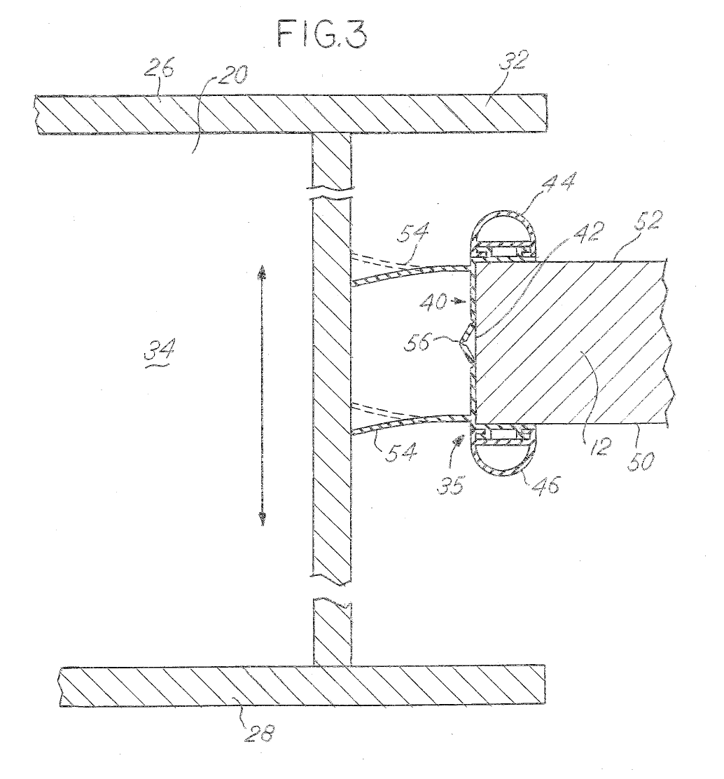

Referring now to the drawings, mobile living quarters, such as the fifth wheel recreational vehicle 10 as shown in FIGS. 1 and 2, include side walls 12 and a ceiling 14. The mobile living quarters 10 is mounted on wheels 16 for transport. An aperture 18, FIG. 2 is provided in one of the side walls 12 and slidably receives a slide-out room 20. The side walls 12 and ceiling 14 cooperate to define a main living area generally indicated by the numeral 22. The slideout room includes side walls 24, a ceiling 26, and a front wall 28. As known to those skilled in the art, the slide-out room 20 is mounted for movement through the aperture 18, so that it may be retracted into the main living quarters 22 when the unit is transported, but can be extended from the main living quarters when the unit is parked for use, thereby providing auxiliary living space. The slide-out room 20 includes a flange 30 extending around the side walls 24 and ceiling wall 26 at the front wall 28 and another flange 32 extending around the side walls 24 and ceiling wall 26 at the ends thereof opposite the ends joined to the front wall 28. The side walls 24, ceiling wall 26 and front wall 28 cooperate to define an auxiliary living area 34, which is available for use when the unit is parked and the slide-out room 20 is moved to the extended position.

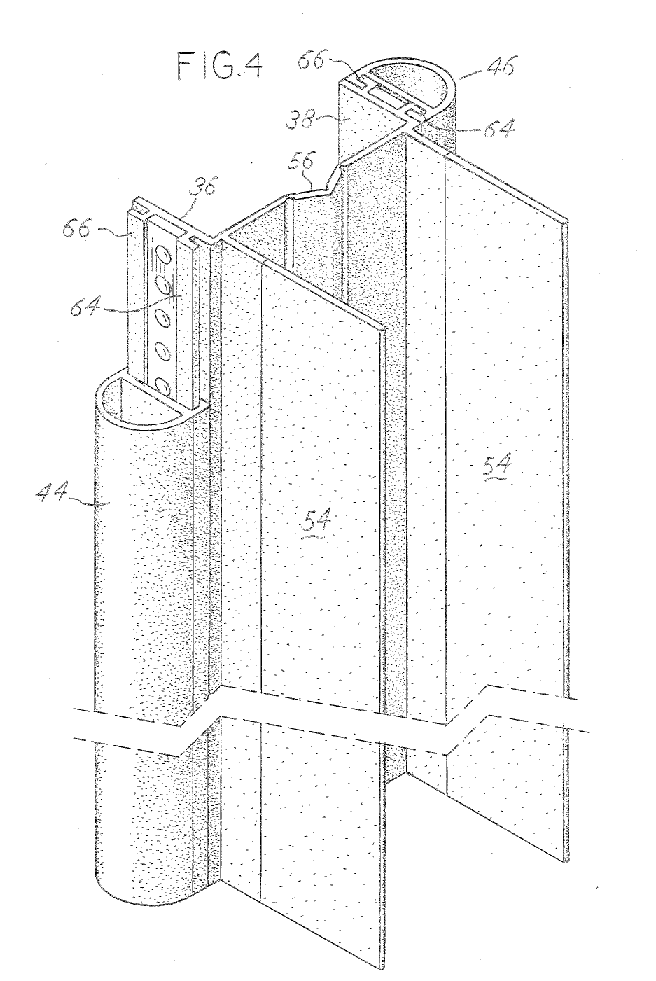

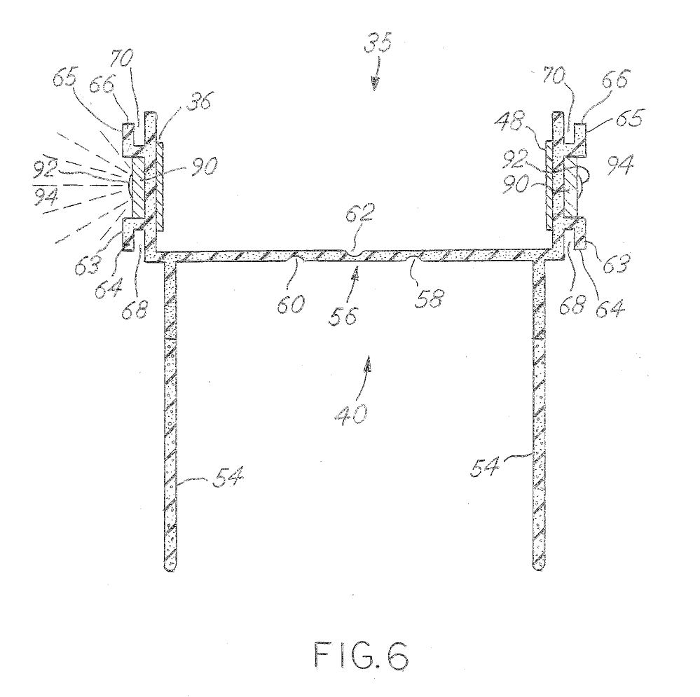

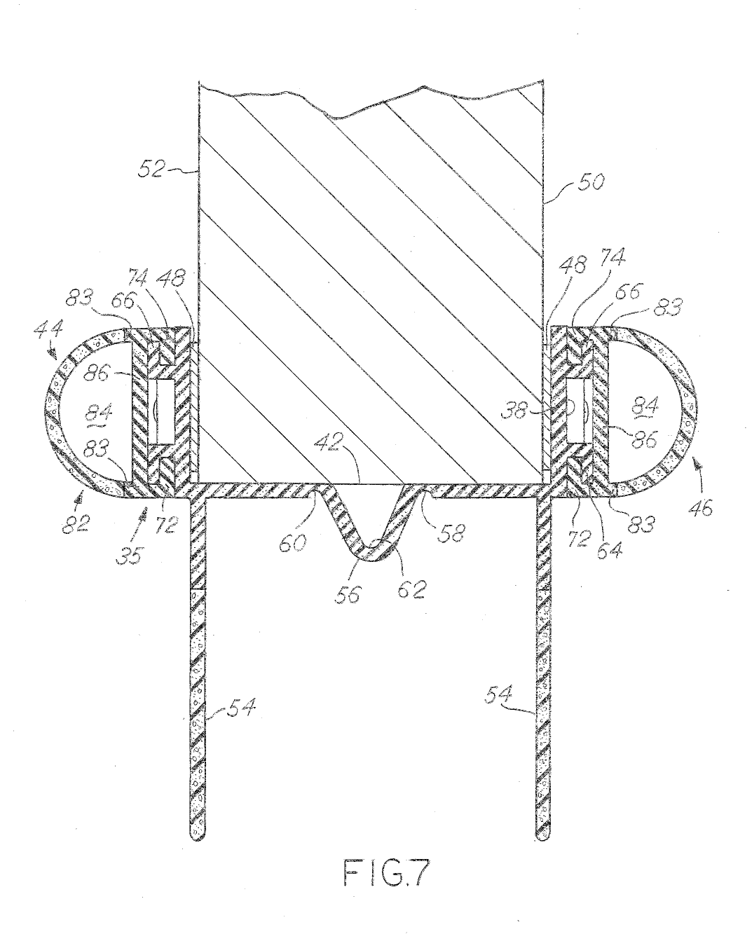

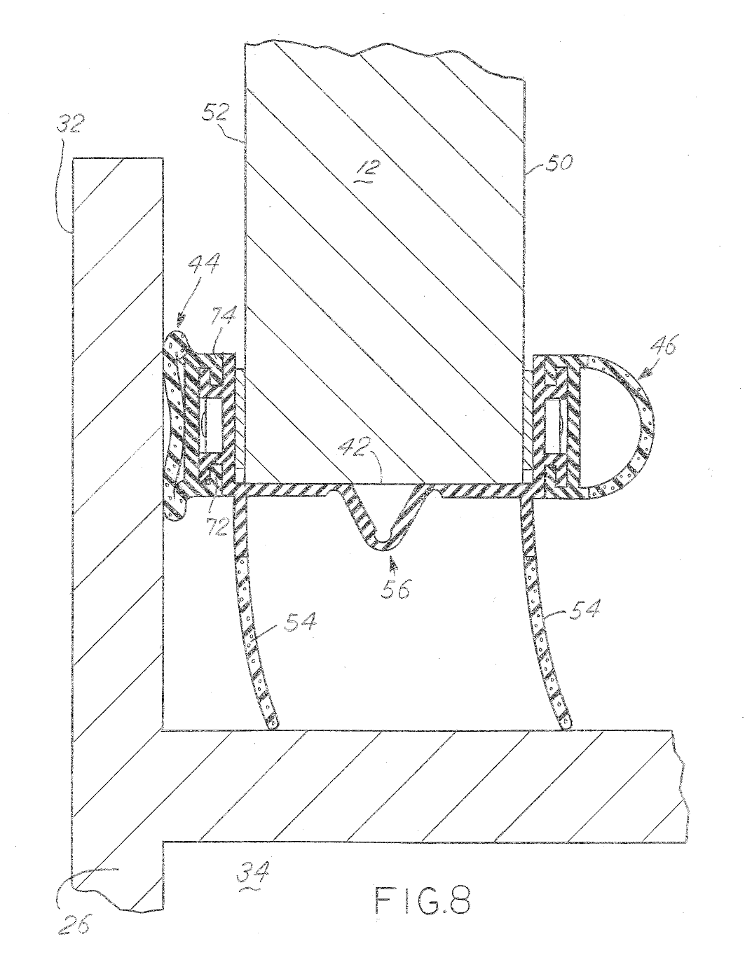

It is necessary to assure that moisture, dirt, debris, etc., be prevented from entering the living quarters. Accordingly, translucent bulb seals 44, 46, FIG. 3 are attached to the seal base 35. The seal base 35 is mounted around the aperture 18 on an outside surface 50 and an interior surface 52 of the side wall 12 adjacent the aperture 18, and a wiper seal 54 engages the side walls 24 and ceiling wall 26 of the slide-out room 20 to wipe against the walls 24, 26 as the slide-out room 20 extends and retracts. The seal base 35, FIGS. 3 and 6 is continuously extruded from different durometer materials with portions having different properties, The continuous extrusion allows the flexibility of different lengths to be cut off and installed. The seal base 35 includes a pair of longitudinal attachment members 36, 38, FIG. 4, which are connected by a longitudinal connecting member 40 FIGS. 3 and 6, which extends over the transverse edge 42 of the sidewall 12. Translucent bulb seals 44, 46, FIG. 3 are manufactured separately and attached to their corresponding attachment members 36 and 38 FIG. 4, as will be hereinafter described. To facilitate installation of the seal base 35 on the unit 10, a strip of double-sided adhesive tape 48 FIG. 6, one side of which is adhesively connected to the side of attachment member 36, is applied to the outside surface 50 of the side wall 12. The opposing attachment member (38, respectively) is positioned against the inside surface 52 of the side wall 12 and the connecting member 40 over the transverse edge 42. The outside of the tape 48 is covered with a removable backing, which is stripped away to expose the adhesive just before the attachment member 38 is applied against the outside surface 50 to thereby hold the seal base 35 FIG. 6 in place. The seal base 35 can later be firmly attached to the corresponding inside and outside surfaces 52 FIG. 3 and 50 by appropriate fasteners as needed, such as screws or nails, before the bulb seals 44, 46 are installed on the attachment members 36, 38, such that the fasteners are driven through the corresponding attachment members 36, 38, and into the side wall 12. Wiper seals 54 extend from the connecting portion 40, FIG. 3 and are adapted to flex against the side walls 24 and ceiling wall 26 of the slide-out room 20 during extension and retraction of the latter.

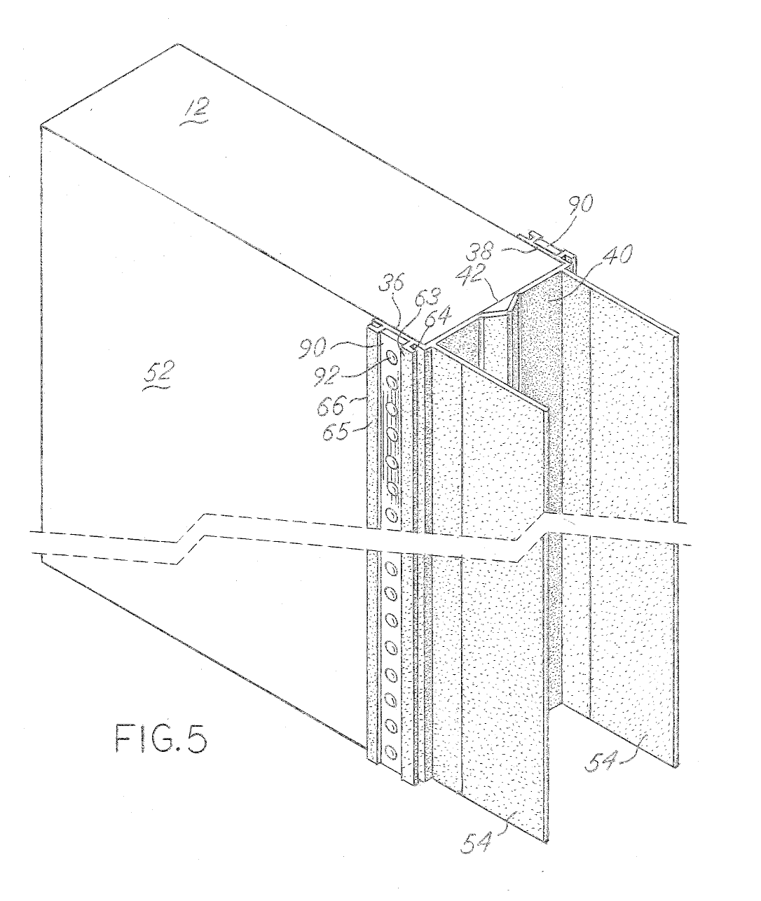

Located between and recessed below outer surfaces 63, 65, FIGS. 5 and 6 of the parallel rails 64, 66 is a luminescent strip 90 that is made up of a string of individual lights 92. The lights 92 are usually LED elements that are wired together. The lights 92 produce light when electrical current is supplied to the luminescent strip 90. Several options, instead of LED, are available as is commonly known in the art. Electroluminescent strips (EL) or incandescent bulbs can be implemented instead of LED. A multi-colored LED strip can also be implemented, giving the user the ability to modify the color of the light being produced by the lights 92. Fading, chasing, or other varying light schemes can be added with the use of a controller. The luminescent strip 90 can be installed on the attachment member 36, 38 that is adjacent to an outside wall, an inside wall, or both as is shown in all FIGS. Installation of the luminescent strip 90 can take place before or after the attachment members 36, 38 are attached to walls 52, 50 respectively. The luminescent strip can be attached to the attachment members 36, 38 through a snap-fit, adhesive, tape, or other means as is commonly known in the art. The luminescent strip 90 can have apertures to allow screws or other fasteners to be driven through the strip 90 or fasteners can be driven through the attachment members 36, 38 before the luminescent strip 90 is attached.

The translucent bulb seals 44, 46 are formed from continuously extruded translucent materials of different durometer. There are inwardly facing tabs 72 and 74, FIGS. 7 and 8 of a higher durometer, forming a groove. A web 86 is formed from a similarly higher durometer. The bulb portion 82 is formed from a lower durometer, giving the bulb portion 82 the ability to deform when pressure is applied. A cavity 84 is created between the web 86 and bulb portion 82. As the bulb portion 82 is compressed, the cavity 84 is reduced in size. At full compression, as shown in FIG. 8, the bulb portion 82 contacts the web 86. Since the web 86 is formed from a higher durometer, it does not deform to the same extent, leaving a gap between the outside surface of the luminescent strip 90 and lights 92, FIG. 6. Maintaining a gap between the luminescent strip 90 and the web 86 prevents damage to the bulb seal 44, 46 and the luminescent strip 90. The higher durometer web 86 can extend partially into the bulb portion 82 forming nubs 83, FIG. 7, giving increased resistance to deforming or crushing.

When the bulb seals 44, 46 are installed on the seal base 35 as is shown in FIGS. 4, 7, and 8, light 94, FIG. 6 must first pass through the web 86 and then the bulb portion 82. The web offers some diffusing effect. The bulb portion 82 further diffuses the light. As with any luminescent strip 90 that contains individual lights 92, the illumination 94 as it leaves the luminescent strip 90 is made up of a string of point source lighting with bright points and dim points, leaving an undesirable pattern. The diffusing effect of the web 86 and bulb portion 82 has a smoothing effect to even out the illumination 94 to create a more cohesive and even look. The bulb seals 44, 46 offer environmental and physical protection to the luminescent strip 90. Outside contaminants must first pass through the tongue 72, 74, FIG. 7 and groove 68, 70, FIG. 6 before it can reach the luminescent strip 90. The luminescent strip 90 is powered externally through a controller or other device to regulate electrical current. Individual luminescent strips 90 can be interconnected, either through the source or connected to adjacent strips, such as the horizontal portion as shown in FIG. 2 at the top of the slide-out room 20 where it meets the adjacent vertical portion on the sides of slide-out room 20.

Should the luminescent strip 90 be installed on only one side, a translucent bulb seal 44, 46 would only be required on the same side. A standard opaque bulb seal 44, 46 could be installed on the non-illuminated side.

Different manufacturers of mobile living quarters manufacture the sidewalls thereof from different materials and thus the sidewalls of different manufacturers are of different thicknesses. However, it is clearly desirable that the number of different variations of the seal base 35 that must be manufactured be minimized. Accordingly, an accordion pleat 56, FIGS. 7 and 8 extends along the length of the connecting member 40 FIG. 5 to permit the width of the connecting member 40 to be adjusted, to thereby accommodate walls of varying thicknesses, as illustrated in FIGS. 6 and 7. In FIG. 7, the seal base 35 is in a “closed” or narrow position, to accommodate a relatively narrow sidewall. In this position, the accordion pleat 56 projects into the space between the wiper seals 54. In FIG. 6, the seal base is in an “open” position, which accommodates the widest sidewall. In this position, the accordion pleat is stretched out so that the connecting member lies substantially flat against the transverse edge 42. It will be noted that as the attachment members 36, 38 FIG. 5 are secured to their corresponding inside and outside surfaces 50, 52 FIG. 3, the width of the connecting member 40 automatically adjusts to accommodate a sidewall of any thickness between those accommodated by the fully open and fully closed positions of FIGS. 6 and 7. The pleat 56 is formed by parallel, longitudinal score lines 58, 60, FIGS. 6 and 7 on the side of the connecting member 40 facing away from the transverse edge 42 and between the wiper seals 54, and by forming a third longitudinal score line 62 on the side of the connecting member 40 that lies against the transverse edge 42 when the seal base is installed on the sidewall. The third score line 62 extends parallel to the score lines 58, 60, and is located midway between them. The first, second and third score lines define corresponding first, second and third fold lines, thereby forming the accordion pleat.

Each of the attachment members 36, 38 are provided with a pair of longitudinal, parallel rails 64, 66, FIGS. 6 and 7, which cooperate with the body of the corresponding attachment member 36 or 38 to define a corresponding pair of grooves 68, 70. Each of the bulb seals 44, 46 are formed with a pair of longitudinal, parallel, inwardly projecting tabs 72, 74, FIGS. 7 and 8 that project toward one another forming a tongue and are received within a corresponding one of the grooves 68 or 70 when the bulb seals 44, 46 are installed on the attachment members 36 and 38. The bulb seals are sufficiently flexible that they may be flexed during installation on the attachment member 36 or 38 to cause the tabs 72, 74 to be received within their corresponding grooves 68 or 70. Alternatively, the bulb seals 44, 46 may be installed upon the attachment members by sliding the bulb seals 44, 46 over the ends of the rails 64, 66 and then sliding the bulb seals along the rails. Before the bulb seals 44, 46 are properly positioned on their corresponding attachment member 36, 38, fasteners (not shown), such as screws or nails, may be driven through the attachment members 36, 38 and then into the side wall 12. Alternatively, after the bulb seals 44, 46 are properly positioned on their corresponding attachment member 36, 38, fasteners (not shown), such as screws or nails, may be driven through the bulb seals 44, 46, through the corresponding attachment members 36, 38 and then into the side wall 12. It will be remembered that prior to installation of the fasteners, the seal base 35 is secured by the tape 48.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. An illuminated seal for living quarters having main living area walls defining a main living area, an aperture in one of said main living area walls slidably receiving a slide out room having slide out room walls defining an auxiliary living space, said one main living area wall having an outside surface, an inside surface, and a transverse surface extending between said inside and outside surfaces, said transverse surface defining said aperture, said seal comprising:
a seal base formed of a single monolithic member and having a first and second mounting portion, said mounting portions adapted for extending along said one main living area wall adjacent to said aperture and connected by a connecting member, said mounting portions being substantially perpendicular to said connecting member, said connecting member substantially parallel to said transverse surface, each of said mounting portions having a pair of parallel L-shaped tabs cooperating to form a tongue, each of said L-shaped tabs having an upstanding portion and an overhang portion, said upstanding portion extending outwardly from said mounting portion, said overhang portion extending from said upstanding portion and substantially parallel to said mounting portion and spaced apart therefrom, said upstanding portions separated by a distance to form a channel, said overhang portions having an outer surface being substantially parallel to said mounting portion;
a luminescent member adapted to produce light and located in said channel between said upstanding portions of said tongue;
a translucent bulb seal having a translucent web portion of a higher durometer and a bulb portion, said web portion forming a first diffuser and a translucent bulb portion of a lower durometer forming a second diffuser, said web portion having a pair of parallel L-shaped tabs extending therefrom cooperating to form a groove, each of said L-shaped tabs having an upstanding portion and an overhang portion, said upstanding portion extending from a lateral edge of said web portion and substantially perpendicular thereto, said overhang portion extending from said upstanding portion and substantially parallel to said web portion, said groove adapted for releaseably mating to said tongue, said bulb portion extending from said web portion opposite of said groove; and
when said luminescent member produces light, said light passes through said first and second diffuser to diffuse said light.

2. The illuminated seal of claim 1, said L-shaped tabs on said seal base facing outward, said L-shaped tabs on said bulb seal facing inward.

3. The illuminated seal of claim 2, said luminescent member is a continuous LED strip having lateral edges, inner surfaces of said L-shaped tabs locate said strip.

4. The illuminated seal of claim 3, said seal having a gap between said luminescent member and said web portion when said bulb seal is engaged with said seal base.

5. The illuminated seal of claim 3, said seal having a gap between said luminescent member and said web portion said bulb seal is in biased contact with one of said slide out room walls.

6. The illuminated seal of claim 5, said web portion including nubs extending outwardly from said upstanding portion into said bulb portion.

7. The illuminated seal of claim 6, said continuous LED strip having a series of discrete LED elements.

8. The illuminated seal of claim 1, said connecting member including a wiper seal extending outwardly therefrom, said wiper seal engaging side walls of said slide out room.

9. The illuminated seal of claim 1, said connecting member including an adjuster for adjusting the distance between the attaching members, said connecting member extending across the transverse surface to permit attaching members to be mounted on their inside and outside surfaces, wherein said adjuster permits the connecting member to be adjusted to accommodate said main living area walls of different thicknesses, said adjuster being an accordion pleat in said connecting member.

10. The illuminated seal of claim 9, said L-shaped tabs on said seal base facing outward, said L-shaped tabs on said bulb seal facing inward.

11. The illuminated seal of claim 10, said luminescent member recessed from an outer surface of said groove.

12. The illuminated seal of claim 11, said seal having a gap between said luminescent member and said web portion when said bulb seal is engaged with said seal base.

13. A seal assembly for living quarters having main living area walls defining a main living area and an aperture in one of said main living area walls slidably receiving a room having room walls defining auxiliary living space, said one main living area wall having an outside surface, an inside surface, and a transverse surface extending between the inside and outside surfaces, said transverse surface defining said aperture, said slide-out room being movable between fully extended and fully retracted positions and carries at least one flange projecting outwardly from said slide-out room walls, said seal assembly comprising;
a seal base having a pair of oppositely located attaching members extending along said one main living area wall at said aperture, one of said attaching members secured to said inside surface, the other of said attaching members secured to said outside surface, said seal base having a connecting member extending between said attaching members and along said transverse surface, at least one of said attaching members carries a pair of parallel rails having an outer surface being spaced from said attaching members, each of said parallel rails cooperating with one said attaching member to define a tongue portion;
a translucent bulb seal having a translucent web portion of a higher durometer and a bulb portion, said web portion forming a first diffuser and a translucent bulb portion of a lower durometer forming a second diffuser, said web portion having a pair of parallel rails extending therefrom cooperating to form a groove, each of said parallel rails having an upstanding portion and an overhang portion, said upstanding portion extending from a lateral edge of said web portion and substantially perpendicular thereto, said overhang portion extending from said upstanding portion and substantially parallel to said web portion, said groove adapted for releaseably mating to said tongue, said bulb portion extending from said web portion opposite of said groove;
an illuminating member carried between said parallel rails of said tongue located between said web portion of said bulb seal and said attaching member when said bulb sealing member is secured to said attaching member, said illuminating member capable of producing light;
when said bulb seal is mounted on at least one of said attaching members, said bulb seal is engaged by said flange when said slide-out room is in said fully extended or fully refracted position; and
when said illuminating member is illuminated, said light passes through said first and second diffuser.

14. The illuminated seal of claim 13, said parallel rails on said seal base facing outward, said parallel rails on said bulb sealing member seal facing inward.

15. The illuminated seal of claim 14, said illuminating member recessed from said outer surface of said groove.

16. The illuminated seal of claim 15, said bulb seal having a gap between said illuminating member and said web portion when said bulb seal is in biased contact with one of said slide out room walls.

17. The illuminated seal of claim 16, said web portion including nubs extending outwardly from said web portion and partially into said bulb portion.

18. The illuminated seal of claim 13, said connecting member including an adjuster for adjusting the distance between the attaching members, said connecting member extending across said transverse surface to permit attaching members to be mounted on said inside and outside surfaces, wherein said adjuster permits the connecting member to be adjusted to accommodate said main living area walls of different thicknesses, said adjuster being an accordion pleat in said connecting member.

19. A seal assembly for mobile living quarters having main living area walls defining a main living area, an aperture in one of said main living area walls slidably receiving a room having room walls defining auxiliary living space; said one main living area wall having an outside surface, an inside surface, and a transverse surface extending between the inside and outside surfaces, said transverse surface defining said aperture, said seal assembly including:
a seal base having a pair of attaching members extending along said one main living area wall at said aperture, said attaching members secured to said inside and outside surfaces, and a connecting member extending between said attaching members and along said transverse surface, said connecting member including an adjuster for adjusting the distance between the attaching members, said connecting member extending across the transverse surface to permit attaching members to be mounted on their inside and outside surfaces, wherein said adjuster permits the connecting member to be adjusted to accommodate said main living area walls of different thicknesses, said adjuster being an accordion pleat in said connecting member, said attaching members having a groove portion, said seal base including an illuminating member disposed between parallel rails of said groove portion; and
a translucent bulb seal having a translucent bulb portion of a lower durometer and a translucent web portion having a higher durometer, said web portion having a tongue adapted to mate to said groove portion on said seal base, said web portion defining a first diffuser, said bulb portion defining a second diffuser.

20. The illuminated seal of claim 19, when said luminescent member produces light, said light passes through said first and second diffuser to diffuse said light.
